(19) United States
(12) Patent Application Publication
(10) Pub. No.: US 2008/0209367 A1
(43) Pub. Date: Aug. 28, 2008

(54) RELIABILITY DESIGN METHOD

(76) Inventor: Kiyohito MUKAI, Kyoto (JP)

Correspondence Address: MCDERMOTT WILL & EMERY LLP, 600 13TH STREET, NW, WASHINGTON, DC, 20005-3096, US

(21) Appl. No.: 12/037,664

(22) Filed: Feb. 26, 2008

(30) Foreign Application Priority Data
Feb. 26, 2007 (JP) 2007-045989

(51) Int. Cl. G06F 17/50

(52) U.S. Cl. 716/4

(57) ABSTRACT

The reliability design method of this invention includes an aged deterioration target extracting step of obtaining a deterioration part where a characteristic is deteriorated through aging in a semiconductor integrated circuit device having a structure corresponding to an initial mask layout pattern; an aged deterioration executing step of creating a deteriorated mask layout pattern corresponding to a structure of the semiconductor integrated circuit device resulting from the aging by modifying the initial mask layout pattern; and an aged deterioration coping step of evaluating a characteristic of the semiconductor integrated circuit device having the structure corresponding to the deteriorated mask layout pattern. In the aged deterioration coping step, the initial mask layout pattern is corrected on the basis of an evaluation result.

### BACKGROUND OF THE INVENTION

The present invention relates to a reliability design method for a semiconductor integrated circuit device including a semiconductor device and a metal interconnection.

In designing a semiconductor integrated circuit device, computer software designated as CAD (computer aided design) or EDA (electronic design automation) is conventionally used for automatically designing the semiconductor integrated circuit device. In designing a mask layout of an electronic circuit (a semiconductor device) included in the semiconductor integrated circuit device, a mask pattern manually designed or automatically designed by using a CAD tool is corrected through verification performed on the basis of a regulation corresponding to a fabrication limit designated as a design rule. Also, a regulation concerned with a product life is provided as a design rule to be used in design and verification in a similar manner.

In accordance with recent development of semiconductor integrated circuit devices, it is necessary to design a semiconductor integrated circuit with high reliability in its life (aging). Physical phenomenon typically concerned with the life of a semiconductor integrated circuit device is electric characteristic degradation due to a hot carrier effect or an antenna effect and physical characteristic degradation due to electro-migration or stress-migration. In order to suppress such degradation, some examples of an apparatus, designated as a reliability design apparatus, that grasps change of the electric characteristic through the aging and analyzes the reliability for optimizing the design of a semiconductor integrated circuit have been proposed as disclosed in, for example, Japanese Laid-Open Patent Publication No. 2003-224258. Such a reliability design apparatus is a reliability design system for a semiconductor integrated circuit device in which reliability design for satisfying the performance concerned with the electric characteristic life required of the semiconductor integrated circuit device can be efficiently performed.

### SUMMARY OF THE INVENTION

Although a reliability design technique for suppressing the electric characteristic degradation due to the hot carrier effect or the antenna effect that affects the performance of a semiconductor device has been conventionally proposed, a reliability design technique for suppressing the physical characteristic degradation concerned with the product life that depends upon a mask layout has not been proposed. Accordingly, in order to improve the reliability of the performance affecting the product life, fabrication regulation for a semiconductor integrated circuit device designated as a design rule depending upon a mask layout has been employed for the design. In such a conventional design method, however, it is difficult to minimize increase of a chip area or to reduce variation depending upon a mask layout simultaneously with the reliability design.

In consideration of this conventional disadvantage, an object of the invention is providing a reliability design method in which a highly reliable semiconductor integrated circuit device having satisfactory performance concerned with its life can be efficiently designed with characteristic degradation through the aging suppressed.

In order to achieve the object, the first reliability design method of this invention in which it is confirmed that a semiconductor integrated circuit device to be designed has a predetermined desired life, includes at least an aged deterioration target extracting step of obtaining aging derived from a shape of a mask layout pattern of every semiconductor device and every metal interconnection included in the semiconductor integrated circuit device; an aged deterioration executing step of calculating a degree of influence on the whole semiconductor integrated circuit device with the obtained aging input; and an aged deterioration characteristic checking step of calculating an electric characteristic of the semiconductor integrated circuit device resulting from the aging with the calculated degree of influence input.

In this reliability design method, not only the initial characteristic of the semiconductor integrated circuit device but also the characteristic of the semiconductor integrated circuit device resulting from the aging are evaluated, and hence, the performance concerned with the product life can be evaluated. Therefore, highly reliable design for attaining a desired life of the semiconductor integrated circuit device can be performed. Furthermore, since the degree of influence on the semiconductor integrated circuit device and the electric characteristic resulting from the aging are calculated, in the case where some parts of, for example, the semiconductor device or the metal interconnection have sufficient reliability also after aged deterioration, the chip area can be reduced while retaining the performance concerned with the life. Therefore, when the reliability design method of this invention is employed, a semiconductor integrated circuit device with high reliability sufficiently satisfying the performance concerned with the life can be designed while suppressing the increase of the chip area.

Furthermore, the second reliability design method of this invention for providing a semiconductor integrated circuit device to be designed with a predetermined desired life, includes an aged deterioration correcting step of preventing reduction of a life through aging by correcting a mask layout pattern of every semiconductor device and every metal interconnection included in the semiconductor integrated circuit device for attaining the predetermined desired life.

In this reliability design method, the mask layout pattern can be corrected by, for example, increasing the width of a metal interconnection in a portion where disconnection is easily caused through the aged deterioration. Therefore, since occurrence of disconnection or the like is reduced, the reduction of the life derived from the aged deterioration is suppressed, and hence, a semiconductor integrated circuit device with a desired life can be designed.

The third reliability design method of this invention in which it is confirmed that a semiconductor integrated circuit device to be designed has a predetermined desired life, includes at least an aged deterioration target extracting step of obtaining aging derived from a shape of a mask layout pattern of every semiconductor device and every metal interconnection included in the semiconductor integrated circuit device; an aged deterioration executing step of calculating a degree of influence on the whole semiconductor integrated circuit device with the obtained aging input; an aged deterioration characteristic checking step of calculating an electric characteristic of the semiconductor integrated circuit device resulting from the aging with the calculated degree of influence input; and an aged deterioration correcting step of preventing reduction of a life through the aging by correcting the mask layout pattern.

In this reliability design method, since the characteristic of the semiconductor integrated circuit device resulting from the aged deterioration is evaluated in the same manner as in the first reliability design method, the performance concerned with the product life can be evaluated. Therefore, a semiconductor integrated circuit device with a desired life can be designed with high reliability. Furthermore, since the mask layout pattern is corrected, it is possible to realize a highly reliable semiconductor integrated circuit device with the reduction of the life through the aged deterioration definitely suppressed.

The fourth reliability design method of this invention includes at least a data inputting step of reading a mask layout pattern corresponding to design information resulting from aging of a semiconductor integrated circuit device to be designed; a characteristic checking step of extracting a characteristic of every semiconductor device and every metal interconnection of the semiconductor integrated circuit device and checking whether or not a predetermined desired life is attained by the extracted characteristic; and an aged deterioration correcting step of complementing aged deterioration in a part of the mask layout pattern where the predetermined desired life is not attained.

In this reliability design method, the characteristic of every semiconductor device or the like is checked by using a CAD tool for DRC or the like on the basis of the mask layout pattern corresponding to design information of the semiconductor integrated circuit device resulting from the aged deterioration. Therefore, the performance concerned with the product life can be evaluated. Furthermore, in the aged deterioration correcting step, a part of the mask layout pattern where the predetermined desired life is not attained can be complemented. Accordingly, when the fourth reliability design method of this invention is employed, a semiconductor integrated circuit device having satisfactory performance concerned with the life can be efficiently designed.

### BRIEF DESCRIPTION OF THE DRAWINGS

FIG. 1 is a block diagram for showing a reliability design method for a semiconductor integrated circuit device according to an embodiment of the present invention.

FIG. 2 is a block diagram for showing the details of an aged deterioration coping step shown in FIG. 1.

FIG. 3A is a diagram of an initial mask layout pattern of metal interconnections used in the embodiment and FIG. 3B is a diagram for explaining Example 1 of an aged deterioration executing step 30.

FIG. 4A is a diagram of an initial mask layout pattern of metal interconnections used in the embodiment and FIG. 4B is a diagram for explaining Example 2 of the aged deterioration executing step 30.

FIG. 5A is a diagram of an initial mask layout pattern of metal interconnections used in the embodiment and FIG. 5B is a diagram for explaining Example 3 of the aged deterioration executing step 30.

FIG. 6A is a diagram of an initial mask layout pattern of metal interconnections used in the embodiment and FIG. 6B is a diagram for explaining Example 4 of the aged deterioration executing step 30.

FIG. 7A is a diagram of an initial mask layout pattern of metal interconnections used in the embodiment and FIG. 7B is a diagram for explaining Example 5 of the aged deterioration executing step 30.

FIG. 8A is a diagram of an initial mask layout pattern of metal interconnections used in the embodiment and FIG. 5B is a diagram for explaining Example 1 of an aged deterioration coping step 50.

FIG. 9A is a diagram of an initial mask layout pattern of metal interconnections used in the embodiment and FIG. 9B is a diagram for explaining Example 2 of the aged deterioration coping step 50.

FIG. 10A is a diagram of an initial mask layout pattern of metal interconnections used in the embodiment and FIG. 10B is a diagram for explaining Example 3 of the aged deterioration coping step 50.

### DETAILED DESCRIPTION OF THE INVENTION

A preferred embodiment of the invention will now be described in detail with reference to the accompanying drawings.

### EMBODIMENT

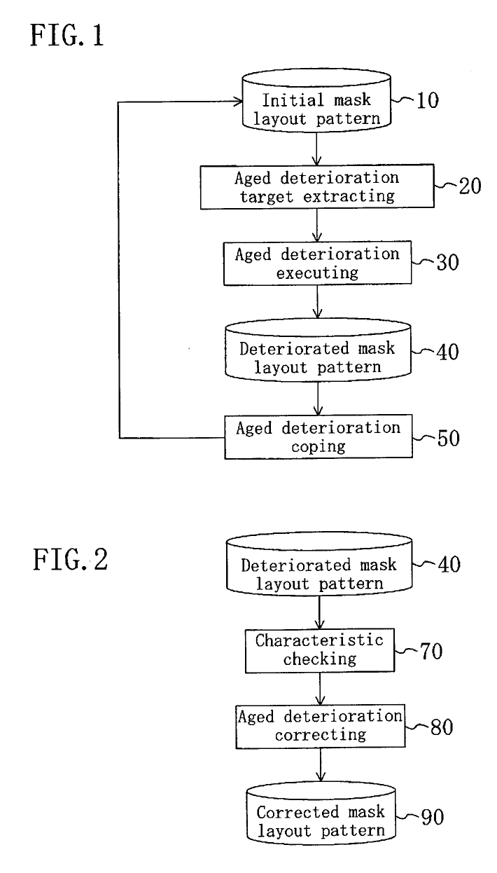

A reliability design method for a semiconductor integrated circuit device including a semiconductor device and a metal interconnection according to an embodiment of the invention will be first described. FIG. 1 is a block diagram for showing an example of the reliability design method for a semiconductor integrated circuit device of this invention.

As shown in FIG. 1, the reliability design method of this embodiment includes an aged deterioration target extracting step 20 of extracting a deterioration part where the aging may occur from a semiconductor integrated circuit device including a semiconductor device and a metal interconnection on the basis of an initial mask layout pattern 10 obtained without considering degradation derived from its life; an aged deterioration executing step 30 of creasing a deteriorated mask layout pattern 40 resulting from the aging by modifying, on the basis of a design rule, the target part (the deterioration part) extracted from the initial mask layout pattern 10 in the aged deterioration target extracting step 20; and an aged deterioration coping step 50 of checking whether or not an initially designed characteristic can be retained with the deteriorated mask layout pattern 40 created in the aged deterioration executing step 30 input. Next, the respective steps will be described.

First, in the aged deterioration target extracting step 20, a target part can be specified and extracted by checking the initial mask layout pattern 10 through DRC (design rule check) performed on the basis of a regulation according to a design rule. Alternatively, a target part can be specified and extracted through lithography rule check (LRC) for reproducing a pattern to be formed on a silicon wafer. It is noted that procedures performed in the steps described below are also executed by using a DRC tool, an LRC tool or the like included in hardware means of a computer or the like in the same manner as this procedure.

Next, in the aged deterioration executing step 30, the target part specified in the initial mask layout patter 10 on the basis of the regulation according to the design rule in the aged deterioration target extracting step 20 is modified, so as to create a deteriorated mask layout pattern 40 corresponding to a semiconductor device or a metal interconnection resulting from the aging. At this point, the deteriorated mask layout pattern 40 is a mask layout pattern obtained by modifying the initial mask layout pattern 10 and hence has the same structure as the initial mask layout pattern 10 excluding the target part.

Subsequently, the aged deterioration coping step 50 will be described. FIG. 2 is a block diagram for showing the aged deterioration coping step 50 in detail. As shown in FIG. 2, the aged deterioration coping step 50 includes a characteristic checking step 70 of extracting circuit information of the semiconductor device or the metal interconnection from the deteriorated mask layout pattern 40 and checking through, for example, circuit simulation, whether or not an initially designed characteristic can be retained; and an aging correcting step 80 of correcting the initial mask layout pattern 10 for creating a corrected mask layout pattern 90 when the initially designed characteristic cannot be retained. It is noted that the procedures of the steps 10 through 50 are executed on the corrected mask layout pattern 90 again as shown in FIG. 1. On the other hand, when it is determined in the aged deterioration coping step 50 that the initially designed characteristic can be retained, the processing is completed. Through the procedures of these steps, the reliability design for a semiconductor integrated circuit device of this embodiment is carried out.

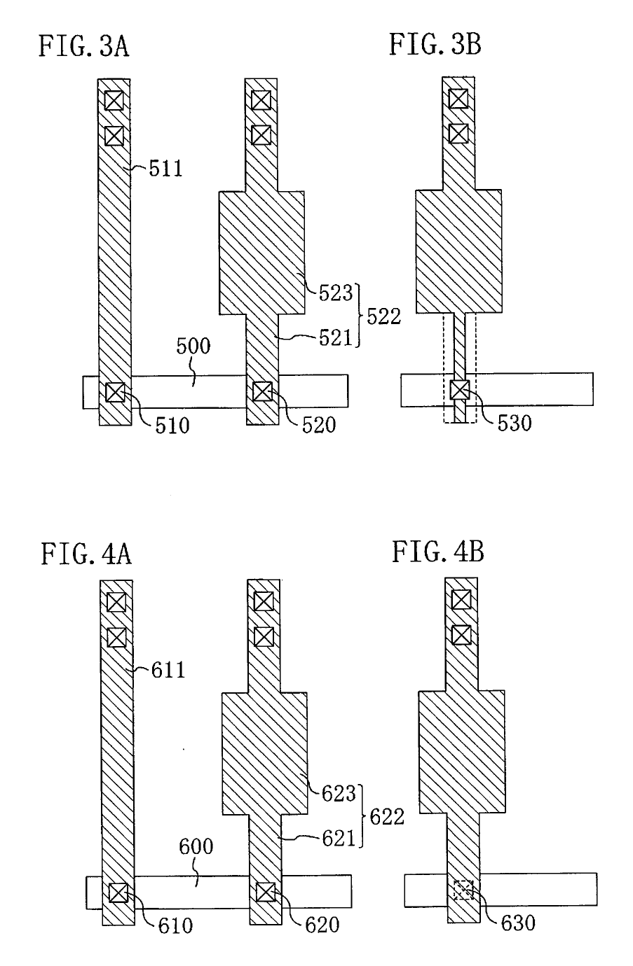

Next, the reliability design method for a semiconductor integrated circuit device including a semiconductor device and a metal interconnection according to this embodiment will be described by giving specific examples. First, specific examples of the aged deterioration executing step 30 of FIG. 1 will be described with reference to FIGS. 3A, 3B, 4A, 4B, 5A, 5B, 6A, 6B, 7A and 7B.

### Example 1 of Aged Deterioration Executing Step 30

FIG. 3A is a diagram of an initial mask layout pattern of metal interconnections of a semiconductor integrated circuit device used in this embodiment and FIG. 3B is a diagram for explaining Example 1 of the aged deterioration executing step 30.

The metal interconnections of the semiconductor integrated circuit device corresponding to the initial mask layout pattern 10 shown in FIG. 3A include a first-layer metal interconnection 500, a first second-layer metal interconnection 511 and a second second-layer metal interconnection 522 provided above the first-layer metal interconnection 500, and a first connection via 510 and a second connection via 520 for respectively connecting the first-layer metal interconnection 500 to the first second-layer metal interconnection 511 and the first-layer metal interconnection 500 to the second second-layer metal interconnection 522. It is noted that the second second-layer metal interconnection 522 includes a first region 521 having the same line width as the first second-layer metal interconnection 511 and a second region 523 having a larger line width than the first region 521.

First, it is determined on the basis of the initial mask layout pattern 10 of FIG. 3A that the second region 523 of the second second-layer metal interconnection 522 has a larger area than the first region 521 and hence a larger number of pores designated as voids are caused in the second region 523. Therefore, in consideration of the life of the semiconductor integrated circuit device over a long period of time in the aged deterioration target extracting step 20, it can be said that there is much possibility of disconnection of the second second-layer metal interconnection 522 due to the influence of the voids. On the other hand, since the first second-layer metal interconnection 511 does not include a region having a different line width and a different area like the second region 523 of the second second-layer metal interconnection 522, voids slightly affect the first second-layer metal interconnection 511, and hence, there is little possibility of disconnection of the first second-layer metal interconnection 511. In this manner, in the aged deterioration target extracting step 20, a target part where the characteristic may be degraded through the aging like disconnection is extracted from the initial mask layout pattern 10 through, for example, the DRC.

Next, in the aged deterioration executing step 30 of this embodiment, the target part specified in the aged deterioration target extracting step 20 is modified on the basis of the design rule as shown in FIG. 3B. In Example 1 of this embodiment the first region 521 of the second second-layer metal interconnection 522 is modified into a sixth region 530 having a smaller line width than the first region 521. Thus, a deteriorated mask layout pattern 40 indicating a risk of the disconnection of the second second-layer metal interconnection 522 can be created.

### Example 2 of Aged Deterioration Executing Step 30

FIG. 4A is a diagram for showing an initial mask layout pattern of metal interconnections of a semiconductor integrated circuit device used in this embodiment and FIG. 4B is a diagram for explaining Example 2 of the aged deterioration executing step 30. Since the initial mask layout pattern shown in FIG. 4A is the same as the initial mask layout pattern shown in FIG. 3A, the detailed description is omitted.

First, in the aged deterioration target extracting step 20 of this example, a first region 621 of a second second-layer metal interconnection 622 is extracted as a target part from the initial layout pattern of FIG. 4A through, for example, the DRC. This is because the second second-layer metal interconnection 622 is easily affected by voids or the like since it includes a second region 623 with a larger area than another region, and hence, it is determined that there is more possibility of disconnection than a first second-layer metal interconnection 611.

Next, in the aged deterioration executing step 30 of this example, the first region 621 of the second second-layer metal interconnection 622 extracted as the target part is modified as shown in FIG. 4B. In this example, the number of second connection vias 620 for connecting a first-layer metal interconnection 600 to the second second-layer metal interconnection 622 is reduced from one to zero. Thus, a deteriorated mask layout pattern 40 indicating a risk of the disconnection of the second second-layer metal interconnection 622 and including a removal region 630 from which the second connection via 620 has been removed can be created.

Although one second connection via 620 is removed in FIG. 4B, in the case where a region including two or more second connection vias 620 is extracted, one or more second connection vias 620 may be appropriately removed.

### Example 3 of Aged Deterioration Executing Step 30

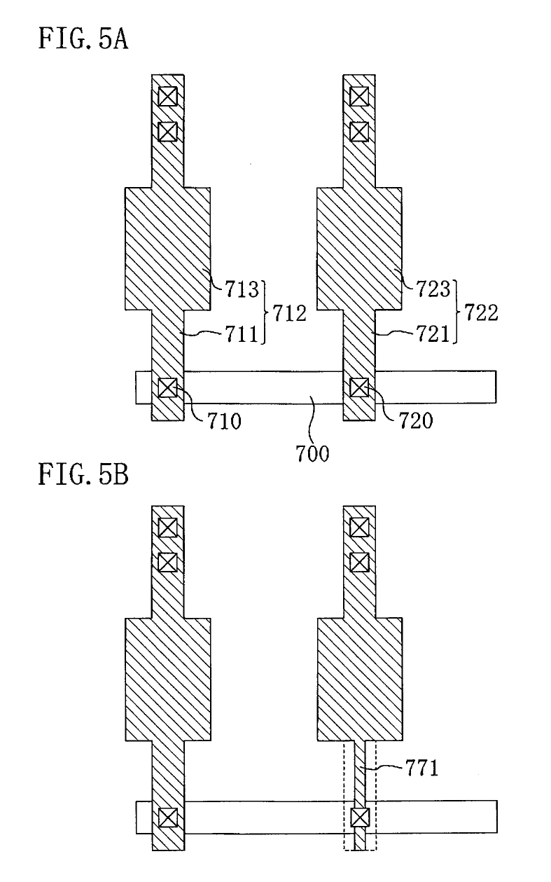

FIG. 5A is a diagram for showing an initial mask layout pattern 10 of metal interconnections of a semiconductor integrated circuit device used in this embodiment, and FIG. 5B is a diagram for explaining Example 3 of the aged deterioration executing step 30.

First, the metal interconnections included in the initial mask layout pattern 10 of FIG. 5A include a first-layer metal interconnection 700, a first second-layer metal interconnection 712 and a second second-layer metal interconnection 722 provided above the first-layer metal interconnection 700, and a first connection via 710 and a second connection via 720 for respectively connecting the first-layer metal interconnection 700 to the first second-layer metal interconnection 712 and the first-layer metal interconnection 700 to the second second-layer metal interconnection 722. The first second-layer metal interconnection 712 includes a first region 711 and a second region 713 having a larger line width than the first region 711, and the second second-layer metal interconnection 722 includes a third region 721 and a fourth region 723 having a larger line width than the third region 721.

In the aged deterioration target extracting step 20 of this example, the first region 711 of the first second-layer metal interconnection 712 and the third region 721 of the second second-layer metal interconnection 722 are extracted as target parts from the initial mask layout pattern of FIG. 5A through the DRC or the like. This is because the first region 711 and the third region 721 are more easily affected by voids or the like since they are respectively adjacent to the second region 713 and the fourth region 723 having a larger area than another region, and hence, it is determined that there is much possibility of disconnection. In addition, probability of the disconnection of each metal interconnection is previously obtained through actual measurement in this example, so that the target parts can be extracted on the basis of the obtained probability. For example, in the case where the line width of the first region 711 or the third region 721 is not more than 0.15 μm, the probability of the disconnection of the first second-layer metal interconnection 712 or the second second-layer metal interconnection 722 is approximately 1 ppm.

Next, in the aged deterioration executing step 30, the width of the third region 721 of the second second-layer metal interconnection 722 extracted as the target part in the aged deterioration target extracting step 20 is reduced, thereby forming a seventh region 771 as shown in FIG. 5B. Thus, a deteriorated mask layout pattern 40 indicating a risk of the disconnection of the second second-layer metal interconnection 722 can be created.

### Example 4 of Aged Deterioration Executing Step 30

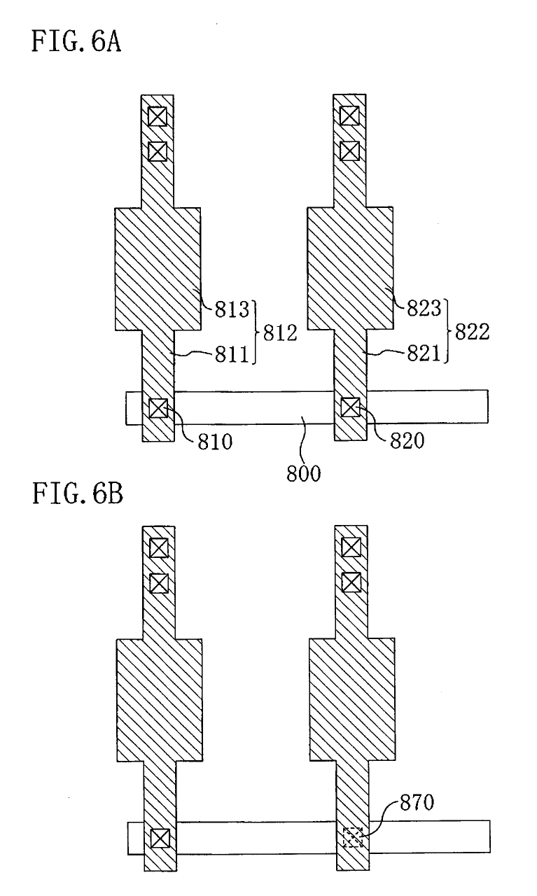

FIG. 6A is a diagram for showing an initial mask layout pattern 10 of metal interconnections of a semiconductor integrated circuit device used in this embodiment, and FIG. 6B is a diagram for explaining Example 4 of the aged deterioration executing step 30. The initial mask layout pattern of FIG. 6A is the same as the initial mask layout pattern shown in FIG. 5A and hence the detailed description is omitted.

First, in the aged deterioration target extracting step 20 of this example, a first connection via 810 for connecting a first second-layer metal interconnection 812 to a first-layer metal interconnection 800 and a second connection via 820 for connecting a second second-layer metal interconnection 822 to the first-layer metal interconnection 800 are extracted as target parts from the initial mask layout pattern of FIG. 6A. This is for the following reason: The first second-layer metal interconnection 812 and the second second-layer metal interconnection 822 are more easily affected by voids since they respectively include a second region 813 and a fourth region 823 with a larger area than another region. Therefore, in consideration of the product life over a long period of time, it is determined that there is much possibility of disconnection in the first connection via 810 and the second connection via 820 respectively connected to the first second-layer metal interconnection 812 and the second second-layer metal interconnection 822. In addition, probability of disconnection of each connection via is previously obtained through the actual measurement in this example, so that the target parts can be extracted on the basis of the obtained probability. For example, in the case where the second region 813 or the fourth region 823 has a line width not more than 0.5 μm, the probability of the disconnection in the first connection via 810 connected to the second region 813 or the second connection via 820 connected to the fourth region 823 is approximately 1 ppm.

Subsequently, in the aged deterioration executing step 30, the number of second connection vias 820 extracted as the target part in the aged deterioration target extracting step 20 is reduced from one to zero. Thus, a deteriorated mask layout pattern 40 indicating a risk of the disconnection of the second connection vias 820 and including no connection via for connecting the first-layer metal interconnection 800 to the second second-layer metal interconnection 822 (see a via removal part 870) can be created.

### Example 5 of Aged Deterioration Executing Step 30

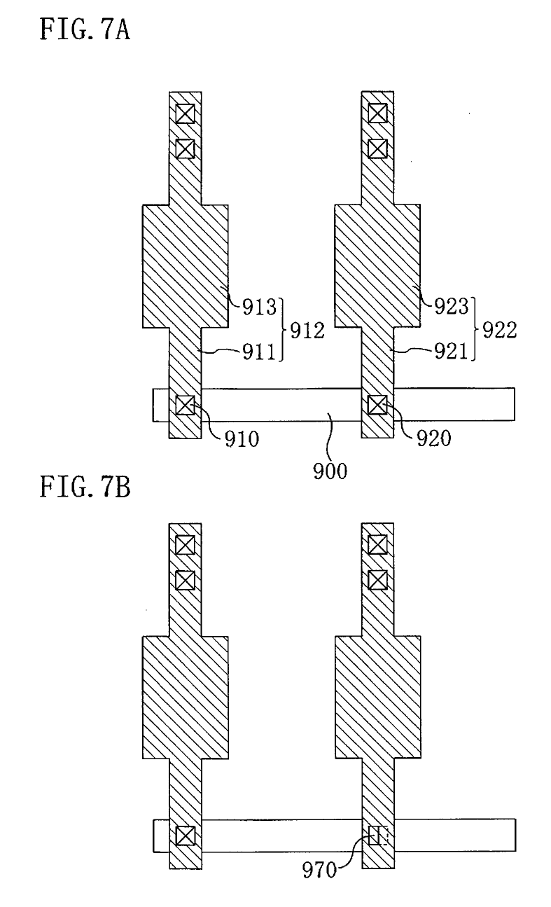

FIG. 7A is a diagram for showing an initial mask layout pattern 10 of metal interconnections of a semiconductor integrated circuit device used in this embodiment, and FIG. 7B is a diagram for explaining Example 5 of the aged deterioration executing step 30. The initial mask layout pattern shown in FIG. 7A is the same as the initial mask layout pattern shown in FIG. 5A and hence the detailed description is omitted.

First, in the aged deterioration target extracting step 20 of this embodiment, a first connection via 910 for connecting a first second-layer metal interconnection 912 to a first-layer metal interconnection 900 and a second connection via 920 for connecting a second second-layer metal interconnection 922 to the fist-layer metal interconnection 900 are extracted as target parts on the basis of the shape of the initial layout pattern shown in FIG. 7A and previously actually measured probability of disconnection in the same manner as in Example 4.

Next, in the aged deterioration executing step 30, the number of second connection vias 920 extracted as the target part in the aged deterioration target extracting step 20 is reduced from one to 0.5. Thus, the second connection via 920 is modified into a fourth connection via 970 having an area in the cross-section along a direction parallel to the metal interconnection halved as compared with the second connection via 920, and in this manner, a deteriorated mask layout pattern 40 indicating a risk of the disconnection of the metal interconnection can be created. In this case, since the number of second connection vias included in the deteriorated mask layout pattern 40 is expressed with a positive real number, the deteriorated mask layout pattern 40 can be created constantly on the basis of the probability previously calculated in the aged deterioration target extracting step 20.

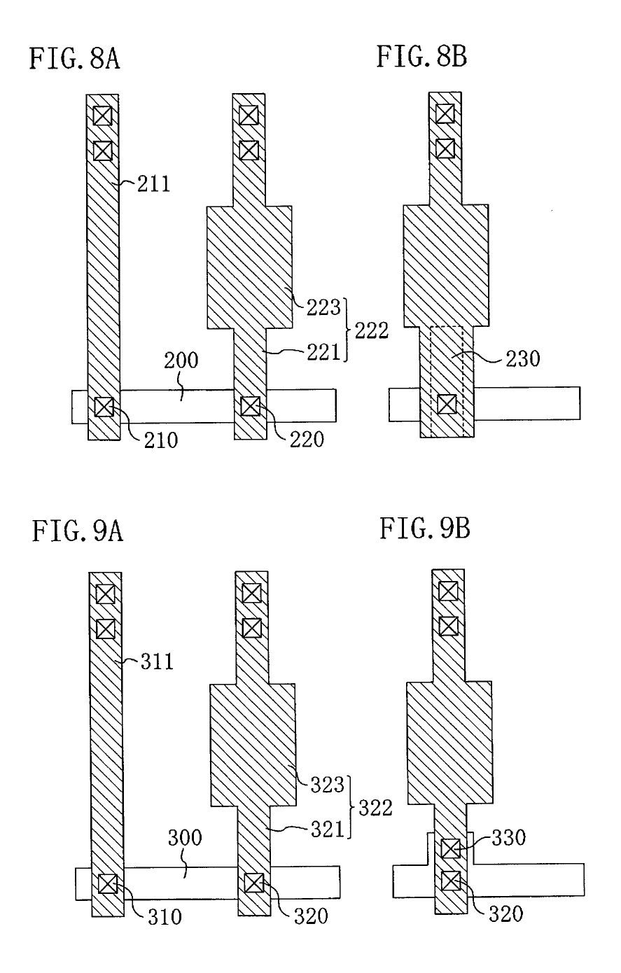

Next, specific examples of the aged deterioration coping step 50 will be described with reference to FIGS. 8A, 8B, 9A, 9B, 10A and 10B.

### Example 1 of Aged Deterioration Coping Step 50

FIG. 8A is a diagram for showing an initial mask layout pattern 10 of metal interconnections of a semiconductor integrated circuit device used in this embodiment, and FIG. 8B is a diagram for explaining Example 1 of the aged deterioration coping step 50. The initial mask layout pattern shown in FIG. 8A is the same as the initial mask layout pattern shown in FIG. 3A and hence the detailed description is omitted.

First, a deteriorated mask layout pattern 40 is created by extracting a target part where there is much possibility of the aging from the initial mask layout pattern shown in FIG. 8A as described in any of the examples of the aged deterioration executing step 30. In this example, a first region 221 of a second second-layer metal interconnection 222 having a second region 223 with a larger area is extracted as a target part in the same manner as in Example 1 of the aged deterioration executing step 30, and the target part is modified so as to create a deteriorated mask layout pattern 40 (not shown).

Next, in the aged deterioration coping step 50, circuit information of every semiconductor device and every metal interconnection is extracted from the deteriorated mask layout pattern 40, and it is determined through, for example, circuit simulation, whether or not an initially designed characteristic can be retained. In the case where it is determined that the initially designed characteristic cannot be retained, the first region 221 of the second second-layer metal interconnection 222 is corrected as shown in FIG. 5B on the basis of the initial mask layout pattern of FIG. 8A. In this example, the first region 221 is modified into a fifth region 230 having a larger line width than the first region 221, so as to create a corrected mask layout pattern 90 (see FIG. 2). Thus, a risk of the disconnection of the metal interconnection of the initial mask layout pattern can be reduced, so that a highly reliable semiconductor integrated circuit device can be designed.

### Example 2 of Aged Deterioration Coping Step 50

FIG. 9A is a diagram for showing an initial mask layout pattern 10 of metal interconnections of a semiconductor integrated circuit device used in this embodiment and FIG. 9B is a diagram for explaining Example 2 of the aged deterioration coping step 50. The initial mask layout pattern shown in FIG. 9A is the same as the initial mask layout pattern shown in FIG. 3A and hence the detailed description is omitted.

First, a deteriorated mask layout pattern 40 is created by extracting a target part where there is much possibility of the aging from the initial mask layout pattern shown in FIG. 9A as described in any of the examples of the aged deterioration executing step 30. In this example, a first region 321 of a second second-layer metal interconnection 322 having a second region 323 with a larger area is extracted as a target part because it is determined that there is much possibility of disconnection of the first region 321 through the aging. Then, the target part is modified so as to create a deteriorated mask layout pattern 40 (not shown).

Next, in the aged deterioration coping step 50, circuit information of every semiconductor device and every metal interconnection is extracted from the deteriorated mask layout pattern 40, and it is determined through, for example, the circuit simulation, whether or not an initially designed characteristic can be retained. In the case where it is determined that the initially designed characteristic cannot be retained, a corrected mask layout pattern 90 (see FIG. 2) is created by increasing the number of vias for connecting the first region 321 of the first second-layer metal interconnection 322 to a first-layer metal interconnection 300 from one to two by additionally providing a fourth connection via 330 in the initial mask layout pattern of FIG. 9A as shown in FIG. 9B. Thus, a risk of the disconnection of the metal interconnection of the initial mask layout pattern 10 can be reduced, so that a highly reliable semiconductor integrated circuit device can be designed.

### Example 3 of Aged Deterioration Coping Step 50

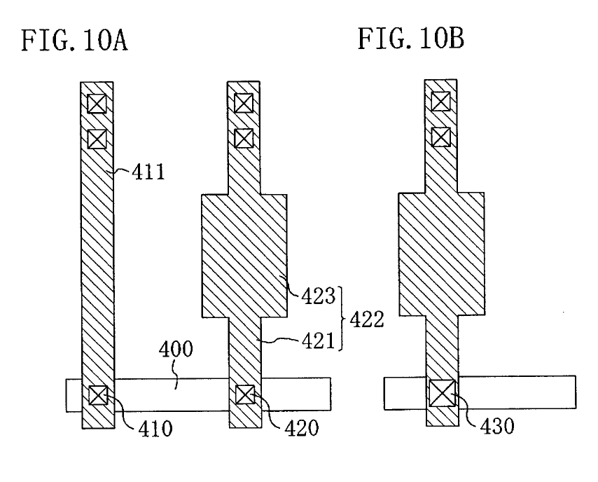

FIG. 10A is a diagram for showing an initial mask layout pattern 10 of metal interconnections of a semiconductor integrated circuit device used in this embodiment, and FIG. 10B is a diagram for explaining Example 3 of the aged deterioration coping step 50, The initial mask layout pattern shown in FIG. 10A is the same as the initial mask layout pattern shown in FIG. 3A and hence the detailed description is omitted.

First, a deteriorated mask layout pattern 40 is created by extracting a target part where there is much possibility of the aging from the initial mask layout pattern shown in FIG. 10A as described in any of the examples of the aged deterioration executing step 30. In this example, a first region 421 of a second second-layer metal interconnection 422 having a second region 423 with a larger area is extracted as a target part because it is determined that there is much possibility of disconnection of the first region 421 through the aging. Then, the target part is modified so as to create a deteriorated mask layout pattern 40 (not shown).

Next, in the aged deterioration coping step 50, circuit information of every semiconductor device and every metal interconnection is extracted from the deteriorated mask layout pattern 40, and it is determined through, for example, the circuit simulation, whether or not an initially designed characteristic can be retained. In the case where it is determined that the initially designed characteristic cannot be retained, a second connection via 420 for connecting the first region 421 to a first-layer metal interconnection 400 is modified, on the basis of the initial mask layout pattern of FIG. 10A, into a third connection via 430 having a larger area in a portion in contact with the first second-layer metal interconnection 422 than the second connection via 420 as shown in FIG. 10B. Thus, a risk of the disconnection of the metal interconnection of the initial mask layout pattern 10 can be reduced, so that a highly reliable semiconductor integrated circuit device can be designed.

As described so far, in the reliability design method of this embodiment, not only the characteristic of a semiconductor integrated circuit device having a structure corresponding to an initial mask layout pattern but also the characteristic of the semiconductor integrated circuit device having a structure corresponding to a deteriorated mask layout pattern resulting from the aging are evaluated, so that a semiconductor integrated circuit device with high reliability in performance concerned with the product life can be designed. In the case where a metal interconnection and a via are designed in consideration of, for example, the electro-migration, it is difficult to obtain a semiconductor integrated circuit device with a desired life merely by using an initial mask layout pattern. Therefore, a deteriorated mask layout pattern resulting from the aging is used, so as to evaluate not only the electro-migration but also other performance concerned with the product life such as the stress-migration, and thus, highly reliable design can be executed for attaining a desired life of the semiconductor integrated circuit device.

Furthermore, since the characteristic is evaluated by using the deteriorated mask layout pattern, in the case where some parts of, for example, a semiconductor device or a metal interconnection have sufficient reliability also after the aged deterioration, the chip area can be reduced while retaining the performance concerned with the life. Therefore, when the reliability design method of this embodiment is employed, a semiconductor integrated circuit device with high reliability sufficiently satisfying the performance concerned with the life can be designed while suppressing the increase of the chip area.

Moreover, since the procedures of the aged deterioration target extracting step 20, the aged deterioration executing step 30 and the aged deterioration coping step 50 are performed by using a CAD tool for the DRC or the like in the reliability design method of this invention, the design procedures can be automatically executed. Therefore, the time and labor necessary for the design of a mask layout pattern can be reduced, so that the reliability design can be efficiently performed.

In this manner, the reliability design method for a semiconductor integrated circuit device of this invention is useful for improving the efficiency of the reliability design of semiconductor integrated circuit devices.

What is claimed is:

1. A reliability design method in which it is confirmed that a semiconductor integrated circuit device to be designed has a predetermined desired life, comprising at least:
an aged deterioration target extracting step of obtaining aging derived from a shape of a mask layout pattern of every semiconductor device and every metal interconnection included in the semiconductor integrated circuit device;
an aged deterioration executing step of calculating a degree of influence on the whole semiconductor integrated circuit device with the obtained aging input; and
an aged deterioration characteristic checking step of calculating an electric characteristic of the semiconductor integrated circuit device resulting from the aging with the calculated degree of influence input.

2. A reliability design method for providing a semiconductor integrated circuit device to be designed with a predetermined desired life, comprising:
an aged deterioration correcting step of preventing reduction of a life through aging by correcting a mask layout pattern of every semiconductor device and every metal interconnection included in the semiconductor integrated circuit device for attaining the predetermined desired life.

3. A reliability design method in which it is confirmed that a semiconductor integrated circuit device to be designed has a predetermined desired life, comprising at least:
an aged deterioration target extracting step of obtaining aging derived from a shape of a mask layout pattern of every semiconductor device and every metal interconnection included in the semiconductor integrated circuit device;
an aged deterioration executing step of calculating a degree of influence on the whole semiconductor integrated circuit device with the obtained aging input;
an aged deterioration characteristic checking step of calculating an electric characteristic of the semiconductor integrated circuit device resulting from the aging with the calculated degree of influence input; and
an aged deterioration correcting step of preventing reduction of a life through the aging by correcting the mask layout pattern.

4. The reliability design method of claim 1 or 3,
wherein a target part is extracted from mask layout information of the semiconductor integrated circuit device through mask layout verification performed on the basis of a regulation of aged deterioration in the aged deterioration target extracting step.

5. The reliability design method of claim 1 or 3,
wherein a target part is extracted from mask layout information of the semiconductor integrated circuit device through lithography rule check performed on the basis of a regulation of aged deterioration in the aged deterioration target extracting step.

6. The reliability design method of claim 1 or 3,
wherein a width of a metal interconnection is changed depending upon an ambient layout mask pattern in mask layout information of the semiconductor integrated circuit device in the aged deterioration executing step.

7. The reliability design method of claim 1 or 3,
wherein in the aged deterioration executing step, the number of connecting portions between metal interconnections is changed depending upon an ambient layout pattern in mask layout information of the semiconductor integrated circuit device on the basis of a regulation of aged deterioration.

8. The reliability design method of claim 1 or 3,
wherein a width of a metal interconnection is changed depending upon an ambient layout pattern in mask layout information of the semiconductor integrated circuit device on the basis of actually measured probability of aged deterioration in the aged deterioration executing step.

9. The reliability design method of claim 1 or 3,
wherein in the aged deterioration executing step, the number of connecting portions between metal interconnections is changed in mask layout information of the semiconductor integrated circuit device on the basis of actually measured probability of aged deterioration.

10. The reliability design method of claim 7,
wherein in the aged deterioration executing step, the number of connecting portions between metal interconnections is changed to a positive real number in the mask layout information of the semiconductor integrated circuit device on the basis of the regulation of the aged deterioration.

11. The reliability design method of claim 2,
wherein in the aged deterioration correcting step, the number of connecting portions between metal interconnections is increased.

12. The reliability design method of claim 2,
wherein an area of a connecting portion between metal interconnections is increased by changing a shape thereof equivalently to increase of the number of connecting portions in the aged deterioration correcting step.

13. A reliability design method comprising at least:
a data inputting step of reading a mask layout pattern corresponding to design information resulting from aging of a semiconductor integrated circuit device to be designed;
a characteristic checking step of extracting a characteristic of every semiconductor device and every metal interconnection of the semiconductor integrated circuit device and checking whether or not a predetermined desired life is attained by the extracted characteristic; and
an aged deterioration correcting step of complementing aged deterioration in a part of the mask layout pattern where the predetermined desired life is not attained.
